(19) United States
(12) Patent Application Publication
(10) Pub. No.: US 2024/0179483 A1
(43) Pub. Date: May 30, 2024

(54) EARBUDS CRADLE AND METHOD FOR IDENTIFYING SIZE OF EAR TIP OF EARBUD USING THE SAME

(71) Applicant: Samsung Electronics Co., Ltd., Suwon-si (KR)

(72) Inventors: Seunghwan KO, Suwon-si (KR); Jungkeun PARK, Suwon-si (KR); Taeseon KIM, Suwon-si (KR); Seonghun JEONG, Suwon-si (KR)

(21) Appl. No.: 18/405,226

(22) Filed: Jan. 5, 2024

Related U.S. Application Data
(63) Continuation of application No. PCT/KR2023/013202, filed on Sep. 5, 2023.

(30) Foreign Application Priority Data
Nov. 24, 2022 (KR) 10-2022-0159788

(51) Int. Cl. H04R 29/00; H04R 1/10

(52) U.S. Cl. CPC H04R 29/001; H04R 1/1016; H04R 1/1025; H04R 1/105; H04R 2420/07

(57) ABSTRACT

An earbuds cradle includes a body, a pair of earbud accommodating grooves provided on a upper surface of the body, a sound reflection deformation portion provided on a bottom of each of the pair of earbud accommodating grooves: and a lid disposed on the body to cover a pair of earbuds.

### CROSS-REFERENCE TO RELATED APPLICATIONS

This application is a continuation of International Application No. PCT/KR2023/013202 designating the United States, filed on Sep. 5, 2023, in the Korean Intellectual Property Receiving Office and claiming priority to Korean Patent Application No. 10-2022-0159788, filed on Nov. 24, 2022, in the Korean Intellectual Property Office, the disclosures of each of which are incorporated by reference herein in their entireties.

### BACKGROUND

### Field

The disclosure relates to an earbuds cradle and a method for identifying a size of an earbud using the earbuds cradle.

### Description of Related Art

Generally, earbuds are sold with an earbuds cradle that has storage and charging functions.

The earbuds cradle includes a pair of accommodation spaces in which a pair of earbuds are accommodated.

An earbud is used in state in which an ear tip is attached to a distal end from which sound is emitted. The user may wear the earbud to which the ear tip is attached to his/her ear. Because the user's ear has various shapes, the appropriate size of an ear tip may vary depending on the user.

Thus, in general, earbuds manufacturers are offering small ear tips, medium ear tips, and large ear tips.

Then, the user may select one of the small ear tips, the medium ear tips, and the large ear tips, attach it to the earbud, and receive and store the earbuds to which the ear tips are attached in the earbuds cradle.

### SUMMARY

An earbuds cradle according to various example embodiments may include: a body; a pair of earbud accommodating grooves provided on a upper surface of the body and configured to accommodate a pair of earbuds; a sound reflection deformation portion provided on a bottom of each of the pair of earbud accommodating grooves; and a lid disposed on the body to cover the pair of earbuds.

The sound reflection deformation portion may comprise a protrusion protruding from the bottom of each of the earbud accommodating grooves.

The protrusion may have a shape of one of a dome, a cylinder, a cone, a truncated cone, a polygonal column, a polygonal pyramid, and a polygonal truncated pyramid. The sound reflection deformation portion may comprise a groove formed in the bottom of each of the earbud accommodating grooves.

The groove may be have a shape of one of a concave curved surface, a circular cross-section groove, a polygonal cross-section groove, a conical groove, a truncated cone groove, a polygonal pyramidal groove, and a polygonal truncated pyramidal groove.

Each of the pair of earbuds may include a distal end including a passage through which sound is emitted: and an ear tip detachably coupled to the distal end. The ear tip may be any one of a large ear tip, a medium ear tip, and a small ear tip. The sound reflection deformation portion may face the ear tip.

The sound reflection deformation portion may be configured so that difference in reflected sound of the sound emitted from the earbud according to a size of the ear tip attached to the earbud is larger than when the bottom of the earbud accommodating groove is flat.

The ear tip may include a coupling part coupled to the distal end of the earbud and through which the sound passes. The sound reflection deformation portion may comprise a protrusion having tip configured to be inserted into the coupling part.

A method for identifying a size of an ear tip of an earbud according to various example embodiments may include: mounting the earbud including the ear tip on an earbuds cradle: emitting sound from a speaker of the earbud: reflecting the sound by a sound reflection deformation portion of the earbuds cradle: inputting the reflected sound to a microphone of the earbud: and identifying the size of the ear tip by comparing an electrical signal, corresponding to the reflected sound, output from the microphone with reference ear tip sound data.

The method may further include identifying that the earbud is defective based on the electrical signal output from the microphone being out of a range of the reference ear tip sound data.

A method for identifying correct wearing of an earbud according to various example embodiments may include: wearing the earbud including an ear tip in a user's ear; emitting sound from a speaker of the earbud: inputting sound reflected by the user's ear to a microphone of the earbud; comparing an electrical signal, corresponding to the reflected sound, output from the microphone with correct wearing sound data to identify whether the earbud is correctly worn or whether a size of the ear tip is suitable for the user's ear: and maintaining a setting value of an equalizer based on the earbud being correctly worn or based on the size of the ear tip being suitable for the user's ear.

The method may further include identifying the size of the ear tip based on the earbud not being correctly worn or based on the size of the ear tip not being suitable for the user's ear; and adjusting the setting value of the equalizer to match the size of the ear tip.

The method may further include comparing the reflected sound with correct wearing adjustment sound data to identify whether the earbud is correctly worn; and recommending replacement of the ear tip based on the earbud not being correctly worn.

The adjusting the setting value of the equalizer to match the size of the ear tip may include increasing intensity of a low frequency band and decreasing intensity of a middle frequency band.

The comparing an electrical signal, corresponding to the reflected sound, output from the microphone with correct wearing sound data to identify whether the earbud is correctly worn may include comparing intensity of the electrical signal output from the microphone with intensity of electrical signals of the correct wearing sound data at a frequency range of 500 Hz to 1000 Hz.

### BRIEF DESCRIPTION OF THE DRAWINGS

These and/or other aspects, features, and advantages of certain embodiments of the present disclosure will be more apparent from the following detailed description, taken in conjunction with the accompanying drawings, in which:

FIG. 1 is a cross-sectional view illustrating an earbuds cradle according to various embodiments;

FIG. 2 is a cross-sectional view illustrating an earbuds cradle without a pair of earbuds according to various embodiments;

FIG. 3 is a diagram illustrating an earbud according to various embodiments;

FIG. 4A is a diagram illustrating an earbud accommodating groove provided with a sound reflection deformation portion having a cone-shape according to various embodiments;

FIG. 4B is a diagram illustrating an earbud accommodating groove provided with a sound reflection deformation portion having a cylindrical shape according to various embodiments;

FIG. 4C is a diagram illustrating an earbud accommodating groove provided with a sound reflection deformation portion having a truncated cone-shape according to various embodiments;

FIG. 4D is a diagram illustrating an earbud accommodating groove provided with a sound reflection deformation portion having a polygonal column shape according to various embodiments;

FIG. 4E is a diagram illustrating an earbud accommodating groove provided with a sound reflection deformation portion having a polygonal pyramid shape according to various embodiments;

FIG. 4F is a diagram illustrating an earbud accommodating groove provided with a sound reflection deformation portion having a polygonal truncated pyramid shape according to various embodiments;

FIG. 5A is a diagram illustrating an earbud accommodating groove provided with a sound reflection deformation portion having a concave curved surface shape according to various embodiments;

FIG. 5B is a diagram illustrating an earbud accommodating groove provided with a sound reflection deformation portion having a circular cross-sectional groove shape according to various embodiments;

FIG. 5C is a diagram illustrating an earbud accommodating groove provided with a sound reflection deformation portion having a polygonal cross-sectional groove shape according to various embodiments;

FIG. 5D is a diagram illustrating an earbud accommodating groove provided with a sound reflection deformation portion having a conical groove shape according to various embodiments;

FIG. 5E is a diagram illustrating an earbud accommodating groove provided with a sound reflection deformation portion having a truncated conical groove shape according to various embodiments;

FIG. 5F is a diagram illustrating an earbud accommodating groove provided with a sound reflection deformation portion having a polygonal pyramidal groove shape according to various embodiments;

FIG. 5G is a diagram illustrating an earbud accommodating groove provided with a sound reflection deformation portion having a polygonal truncated pyramidal groove shape according to various embodiments;

FIG. 6 is a graph illustrating frequency characteristic curves of an electrical signal output from a microphone according to a shape of a sound reflection deformation portion according to various embodiments;

FIG. 7A is a diagram illustrating a large ear tip attached to an earbud according to various embodiments;

FIG. 7B is a diagram illustrating a medium ear tip attached to an earbud according to various embodiments;

FIG. 7C is a diagram illustrating a small ear tip attached to an earbud according to various embodiments;

FIG. 8 is a diagram illustrating an example of an audio system using earbuds according to various embodiments;

FIG. 9 is a block diagram illustrating an example configuration of an earbud according to various embodiments;

FIG. 10 is a graph illustrating a signal output from a microphone according to the size of an ear tip of an earbud mounted on an earbuds cradle without a sound reflection deformation portion according to various embodiments;

FIG. 11 is a graph illustrating a signal output from a microphone according to the size of an ear tip of an earbud mounted on an earbuds cradle having a sound reflection deformation portion according to various embodiments;

FIG. 12 is a flowchart illustrating an example method for identifying a size of an ear tip of an earbud according to various embodiments;

FIG. 13 is a flowchart illustrating an example method for identifying correct wearing of earbuds according to various embodiments;

FIG. 14 is a graph illustrating electrical signals output from a microphone when an earbud is correctly worn in an ear canal of an ear and when a distance between the earbud and the ear canal is greater than when the earbud is correctly worn in the ear canal of the ear according to various embodiments; and

FIG. 15 is a flowchart illustrating an example method for identifying correct wearing of earbuds according to various embodiments.

### DETAILED DESCRIPTION

Since the embodiments of the disclosure can apply various transformations and have various embodiments, example embodiments will be illustrated in the drawings and described in greater detail in the detailed description. However, this is not intended to limit the scope to the example embodiments, and should be understood to include various modifications, equivalents, and/or alternatives of the embodiment of the disclosure. In connection with the description of the drawings, like reference numerals may be used for like elements.

In describing the disclosure, when it is determined that a detailed description of a related known function or configuration may unnecessarily obscure the gist of the disclosure, a detailed description thereof may be omitted.

In addition, the following example embodiments may be modified in many different forms, and the scope of the technical idea of the disclosure is not limited to the following example embodiments. Rather, these embodiments are provided so that this disclosure will be thorough and complete, and will fully convey the spirit of the disclosure to those skilled in the art.

Terms used in this disclosure are used to describe example embodiments, and are not intended to limit the scope of rights. Singular expressions include plural expressions unless the context clearly dictates otherwise.

In this disclosure, expressions such as “has,” “can have”, “includes,” or “can include” indicate the existence of a corresponding feature (e.g., numerical value, function, operation, or component such as a part) and do not preclude the existence of additional features.

In this disclosure, expressions such as “A or B,” “at least one of A or/and B,” or “one or more of A or/and B” may include all possible combinations of the items listed together. For example, “A or B,” “at least one of A or/and B,” or “one or more of A or/and B” may refer to all cases (1) including at least one A, (2) including at least one B, or (3) including both at least one A and at least one B.

Expressions such as “first,” “second,” “primary,” or “secondary,” as used in this disclosure may refer to various components regardless of order and/or importance, are used only to distinguish one component from other components, and do not limit the corresponding components.

Further, terms such as ‘leading end’, ‘rear end’, ‘upper side’, ‘lower side’, ‘top end’, ‘bottom end’, etc. used in the disclosure are defined with reference to the drawings. However, the shape and position of each component are not limited by these terms.

Hereinafter, various example embodiments of an earbuds cradle according to the disclosure will be described in greater detail with reference to the accompanying drawings.

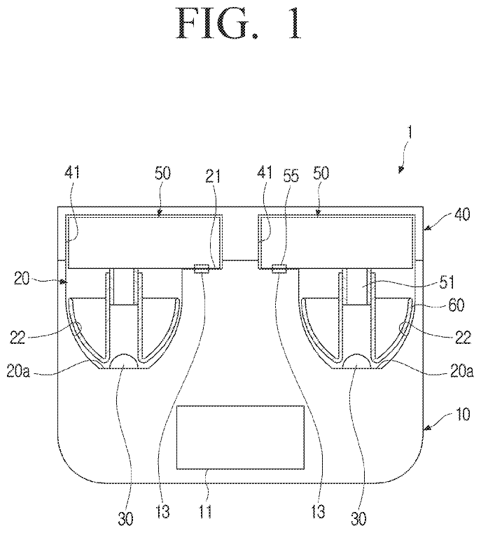

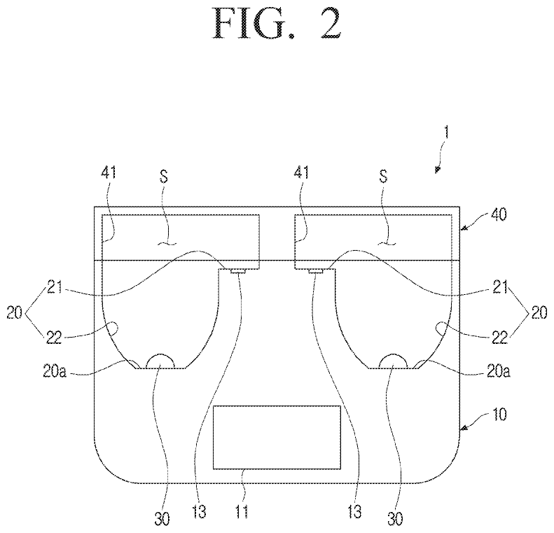

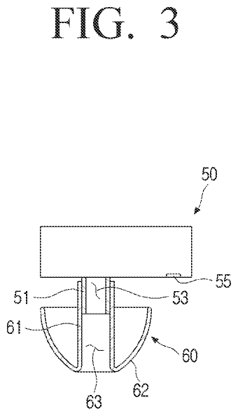

FIG. 1 is a cross-sectional view illustrating an earbuds cradle 1 according to various embodiments. FIG. 2 is a cross-sectional view illustrating an earbuds cradle 1 without a pair of earbuds according to various embodiments. FIG. 3 is a diagram illustrating an earbud 50 of an earbuds cradle 1 according to various embodiments.

Referring to FIGS. 1, 2 and 3, an earbuds cradle 1 according to various embodiments may include a body 10, a lid 40, and a pair of earbuds 50.

The body 10 forms the appearance of the earbuds cradle 1 and is formed to accommodate the pair of earbuds 50.

A pair of earbud accommodating grooves 20 may be formed on the upper surface of the body 10. The pair of earbud accommodating grooves 20 may be identically formed. Therefore, only one earbud accommodating groove 20 will be described below.

The earbud accommodating groove 20 may be formed on the upper surface of the body 10. The earbud accommodating groove 20 may be formed in a shape corresponding to the shape of the earbud 50 to accommodate the earbud 50. A sound reflection deformation portion 30 may be provided on the bottom 20a of the earbud accommodating groove 20.

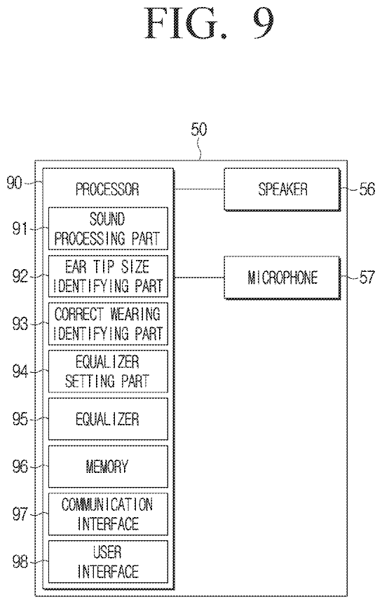

The sound reflection deformation portion 30 may be formed to reflect sound emitted from a speaker 56 (e.g., refer to FIG. 9) of the earbud 50. The sound reflection deformation portion 30 is not formed in a plane. The sound reflection deformation portion 30 may be formed as a protrusion protruding from the bottom 20a. The sound reflection deformation portion 30 may be formed as a concave groove in the bottom 20a. The sound reflection deformation portion 30 may be formed as a concave-convex shape on the bottom 20a.

The earbud accommodating groove 20 may include a seating portion 21 on which the earbud 50 is placed and a cavity 22 in which an ear tip 60 attached to the earbud 50 is accommodated.

The seating portion 21 may be formed in a shape corresponding to the lower shape of the earbud 50 to support the earbud 50. Power terminals 13 capable of supplying power to the earbud 50 may be provided in the seating portion 21. The power terminals 13 of the seating portion 21 may be provided to correspond to power terminals 55 provided in the earbud 50.

The cavity 22 is connected to the seating portion 21 and may be formed deeper than the seating portion 21. An inner surface of the cavity 22 may be formed as a curved surface. The bottom surface of the cavity 22 may form the bottom 20a of the earbud accommodating groove 20.

The sound reflection deformation portion 30 may be provided on the bottom surface of the cavity 22, that is, the bottom 20a of the earbud accommodating groove 20. The sound reflection deformation portion 30 may be provided to face the ear tip 60.

The sound reflection deformation portion 30 may be formed to reflect sound emitted from the earbud 50 accommodated in the earbud accommodating groove 20. The sound reflection deformation portion 30 may be formed such that a difference in characteristics of reflected sound increases according to the size of the ear tip 60 attached to the earbud 50.

For example, the sound reflection deformation portion 30 may be formed such that a difference between the characteristics of the reflected sound that sound emitted from the earbud 50 coupled with the large ear tip 60 is reflected by the sound reflection deformation portion 30 and the characteristics of the reflected sound that sound emitted from the earbud 50 coupled with the small ear tip 60 is reflected by the sound reflection deformation portion 30 is large.

When the sound reflection deformation portion 30 is formed as described above, the difference between the characteristics of the reflected sound that sound emitted from the earbud 50 coupled with the large ear tip 60 is reflected by the sound reflection deformation portion 30 and the characteristics of the reflected sound that sound emitted from the earbud 50 coupled with the small ear tip 60 is reflected by the sound reflection deformation portion 30 may be greater than the difference between the characteristics of the reflected sound that sound emitted from the earbud 50 coupled with the large ear tip 60 is reflected by the bottom 20a and the characteristics of the reflected sound that sound emitted from the earbud 50 coupled with the small ear tip 60 is reflected by the bottom 20a when the bottom 20a of the earbud accommodating groove 20 is flat, that is, when there is no sound reflection deformation portion 30 on the bottom 20a of the earbud accommodating groove 20.

The sound reflection deformation portion 30 may be formed such that a difference between the characteristics of the reflected sound that sound emitted from the earbud 50 coupled with the large ear tip 60 is reflected by the sound reflection deformation portion 30 and the characteristics of the reflected sound that sound emitted from the earbud 50 coupled with the medium ear tip 60 is reflected by the sound reflection deformation portion 30 is large.

When the sound reflection deformation portion 30 is formed as described above, the difference between the characteristics of the reflected sound that sound emitted from the earbud 50 coupled with the large ear tip 60 is reflected by the sound reflection deformation portion 30 and the characteristics of the reflected sound that sound emitted from the earbud 50 coupled with the medium ear tip 60 is reflected by the sound reflection deformation portion 30 may be greater than the difference between the characteristics of the reflected sound that sound emitted from the earbud 50 coupled with the large ear tip 60 is reflected by the bottom 20a and the characteristics of the reflected sound that sound emitted from the earbud 50 coupled with the medium ear tip 60 is reflected by the bottom 20a when the bottom 20a of the earbud accommodating groove 20 is flat, that is, when there is no sound reflection deformation portion 30 on the bottom 20a of the earbud accommodating groove 20. The sound reflection deformation portion 30 may be formed such that a difference between the characteristics of the reflected sound that sound emitted from the earbud 50 coupled with the medium ear tip 60 is reflected by the sound reflection deformation portion 30 and the characteristics of the reflected sound that sound emitted from the earbud 50 coupled with the small ear tip 60 is reflected by the sound reflection deformation portion 30 is large.

When the sound reflection deformation portion 30 is formed as described above, the difference between the characteristics of the reflected sound that sound emitted from the earbud 50 coupled with the medium ear tip 60 is reflected by the sound reflection deformation portion 30 and the characteristics of the reflected sound that sound emitted from the earbud 50 coupled with the small ear tip 60 is reflected by the sound reflection deformation portion 30 may be greater than the difference between the characteristics of the reflected sound that sound emitted from the earbud 50 coupled with the medium ear tip 60 is reflected by the bottom 20a and the characteristics of the reflected sound that sound emitted from the earbud 50 coupled with the small ear tip 60 is reflected by the bottom 20a when the bottom 20a of the earbud accommodating groove 20 is flat, that is, when there is no sound reflection deformation portion 30 on the bottom 20a of the earbud accommodating groove 20. The sound reflection deformation portion 30 may be formed as a protrusion protruding from the bottom 20a of the earbud accommodating groove 20. For example, in the embodiment shown in FIGS. 1 and 2, the protrusion 30 is formed in a dome shape.

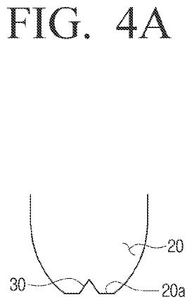

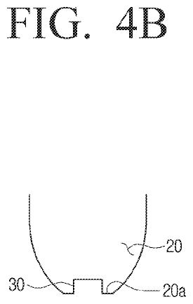

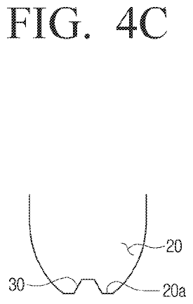

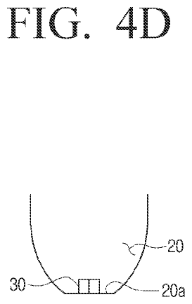

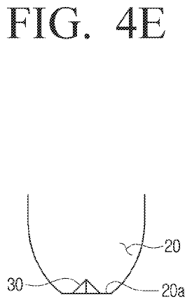

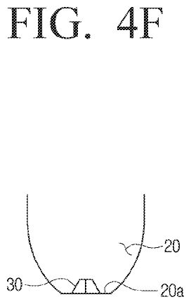

However, the shape of the protrusion 30 is not limited thereto. For example, as illustrated in FIGS. 4A, 4B, 4C, 4D and 4F, the protrusion 30 may, for example, and without limitation, be formed in any one of a cylindrical shape, a cone shape, a truncated cone shape, a polygonal column shape, a polygonal pyramid shape, a polygonal truncated pyramid shape.

FIG. 4A is a diagram illustrating an earbud accommodating groove 20 provided with a sound reflection deformation portion 30 having a cone-shape according to various embodiments. FIG. 4B is a diagram illustrating an earbud accommodating groove 20 provided with a sound reflection deformation portion 30 having a cylindrical shape according to various embodiments. FIG. 4C is a diagram illustrating an earbud accommodating groove 20 provided with a sound reflection deformation portion 30 having a truncated cone shape according to various embodiments. FIG. 4D is a diagram illustrating an earbud accommodating groove 20 provided with a sound reflection deformation portion 30 having a polygonal column shape according to various embodiments. For reference, FIG. 4D illustrates a triangular column as an example of the polygonal column. FIG. 4E is a diagram illustrating an earbud accommodating groove 20 provided with a sound reflection deformation portion 30 having a polygonal pyramidal shape according to various embodiments. For reference, FIG. 4E illustrates a triangular pyramid as an example of the polygonal pyramid. FIG. 4F is a diagram illustrating an earbud accommodating groove 20 provided with a sound reflection deformation portion 30 having a polygonal truncated pyramidal shape according to various embodiments. For reference, FIG. 4F illustrates a triangular truncated pyramid as an example of the polygonal truncated pyramid.

When the sound reflection deformation portion 30 is formed as a protrusion, the tip of the protrusion may be formed to be inserted into a coupling part 61 of the ear tip 60 of the earbud 50.

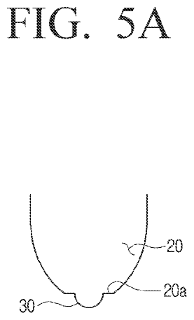

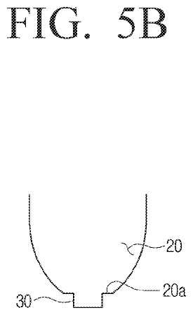

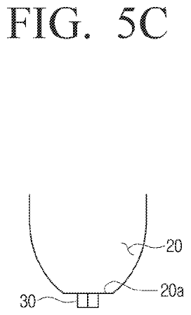

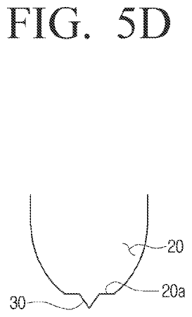

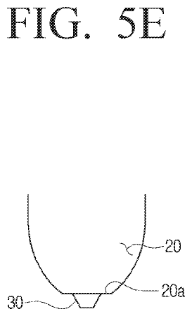

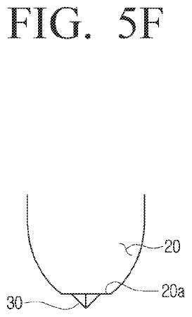

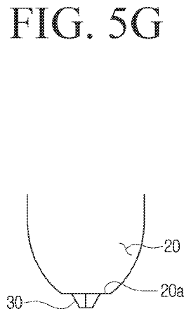

Alternatively, the sound reflection deformation portion 30 may be formed as a groove formed in the bottom 20a of the earbud accommodating groove 20. For example, as illustrated in FIGS. 5A, 5B, 5C, 5D, 5E, 5F and 5G, the groove may, for example, and without limitation, be formed in any one shape of a concave curved surface, a circular cross-sectional groove, a polygonal cross-sectional groove, a conical groove, a truncated cone groove, a polygonal pyramidal groove, and a polygonal truncated pyramidal groove.

FIG. 5A is a diagram illustrating an earbud accommodating groove 20 provided with a sound reflection deformation portion 30 having a concave curved surface shape according to various embodiments. FIG. 5B is a diagram illustrating an earbud accommodating groove 20 provided with a sound reflection deformation portion 30 having a circular cross-sectional groove shape according to various embodiments. FIG. 5C is a diagram illustrating an earbud accommodating groove 20 provided with a sound reflection deformation portion 30 having a polygonal cross-sectional groove shape according to various embodiments. For reference, FIG. 5C illustrates a triangular cross-sectional groove as an example of the polygonal cross-sectional groove.

FIG. 5D is a diagram illustrating an earbud accommodating groove 20 provided with a sound reflection deformation portion 30 having a conical groove shape according to various embodiments. FIG. 5E is a diagram illustrating an earbud accommodating groove 20 provided with a sound reflection deformation portion 30 having a truncated conical groove shape according to various embodiments. FIG. 5F is a diagram illustrating an earbud accommodating groove 20 provided with a sound reflection deformation portion 30 having a polygonal pyramidal groove shape according to various embodiments. For reference, FIG. 5F illustrates a triangular pyramidal groove as an example of the polygonal pyramidal groove. FIG. 5G is a diagram illustrating an earbud accommodating groove provided with a sound reflection deformation portion having a polygonal truncated pyramidal groove shape according to various embodiments. For reference, FIG. 5G illustrates a triangular truncated pyramidal groove as an example of the polygonal truncated pyramidal groove.

Alternatively, the sound reflection deformation portion 30 may be formed as various patterns having concave-convex shapes on the bottom 20a of the earbud accommodating groove 20, and is not limited to the various shapes illustrated by way of non-limiting example above.

Depending on the shape of the sound reflection deformation portion 30, a frequency characteristic curve of the reflected sound may change. For example, sound output from the earbud 50 may be reflected by the sound reflection deformation portion 30 and input to a microphone 57 (see FIG. 9). The microphone 57 may be configured to output the received sound as an electrical signal. At this time, the frequency characteristic curve of the electrical signal output from the microphone 57 may change according to the shape of the sound reflection deformation portion 30.

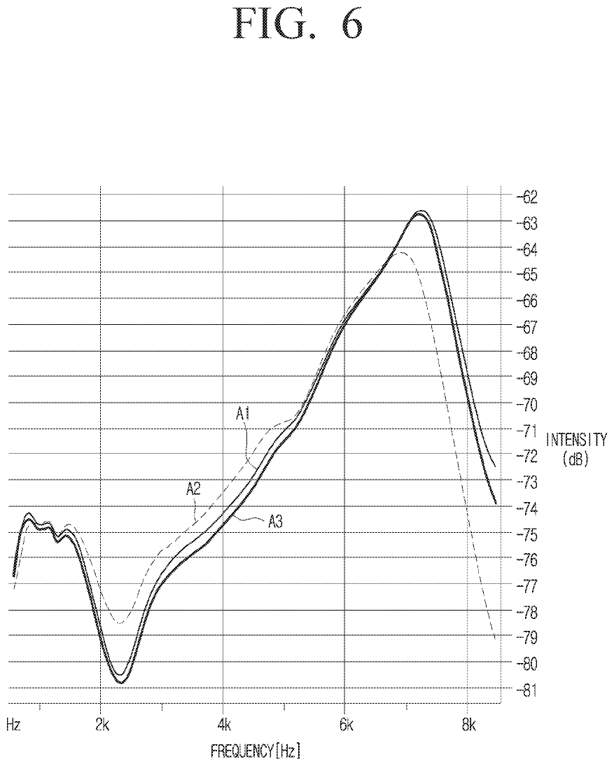

FIG. 6 is a graph illustrating frequency characteristic curves of electrical signals output from a microphone according to a shape of a sound reflection deformation portion according to various embodiments.

In FIG. 6, curve A1 illustrates a case in which the sound reflection deformation portion 30 is formed as a conical protrusion as illustrated in FIG. 4A. In this case, the height of the conical protrusion is about 1 mm. Curve A2 illustrates a case in which the sound reflection deformation portion 30 is formed as a cylindrical protrusion as illustrated in FIG. 4B. In this case, the height of the cylindrical protrusion is about 1 mm. Curve A3 illustrates a case in which the sound reflection deformation portion 30 is formed as a cylindrical groove as illustrated in FIG. 5B. In this case, the depth of the cylindrical groove is about 1 mm.

A power supply 11 may be provided in the body 10. The power supply 11 may be electrically connected to the power terminals 13 of the seating portion 21. The power supply 11 may include a rechargeable battery.

The lid 40 may be disposed on the body 10 to cover the pair of earbuds 50. The lid 40 may be formed to cover the pair of earbuds 50 accommodated in the pair of earbud accommodating grooves 20 of the body 10. The lid 40 may be detachably disposed on the body 10. The lid 40 may be disposed by a hinge in the body 10 to open and cover the pair of earbud accommodating grooves 20.

A pair of lid grooves 41 may be formed on the lower surface of the lid 40 facing the upper surface of the body 10. The pair of lid grooves 41 may be formed to correspond to the pair of earbud accommodating grooves 20 provided in the body 10. Accordingly, the earbud accommodating groove 20 of the body 10 and the lid grooves 41 of the lid 40 may form an accommodating space S in which the earbud 50 is accommodated.

The accommodating space S may be blocked from external sound by the body 10 and the lid 40. In other words, external sound cannot penetrate into the accommodating space S.

The pair of earbuds 50 may be accommodated in the pair of earbud accommodating grooves 20 of the body 10. Because the pair of earbuds 50 are identically or similarly formed, only one earbud 50 will be described below for convenience.

The earbud 50 may include a speaker 56 (e.g., refer to FIG. 9) configured to generate sound and a microphone 57 (e.g., refer to FIG. 9) configured to receive and covert sound into audio current.

The earbud 50 may include a distal end 51. The distal end 51 may include a passage 53 through which sound emitted from the speaker 56 of the earbud 50 passes. The speaker 56 may be disposed inside the earbud 50 and communicate with the passage 53 of the distal end 51. Accordingly, sound emitted from the speaker 56 may be emitted to the outside of the earbud 50 through the passage 53 of the distal end 51.

The microphone 57 (e.g., refer to FIG. 9) may be disposed in the earbud 50 to receive external sound.

The earbud 50 may include the ear tip 60. The ear tip 60 may be detachably coupled to the distal end 51. The ear tip 60 may be formed in a shape corresponding to a person's ear canal or other part of the ear.

The ear tip 60 may include a coupling part 61 and a cap part 62. The coupling part 61 may be formed to be coupled to the distal end 51 of the earbud 50. The coupling part 61 may be formed in a hollow pipe shape to allow sound to pass through. Accordingly, the coupling part 61 may include a passage 63 through which sound passes. The coupling part 61 may be formed in a shape corresponding to the distal end 51 of the earbud 50. Thus, the ear tip 60 may be coupled to or separated from the distal end 51 of the earbud 50.

The cap part 62 may be formed to extend outward from one end of the coupling part 61. The cap part 62 may be formed in a substantially hemispherical shape. The cap part 62 may provide a flexible surface to contact the user's ear canal.

The ear tip 60 may be formed of an elastic material such as silicone rubber.

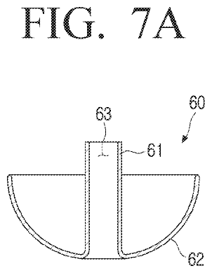

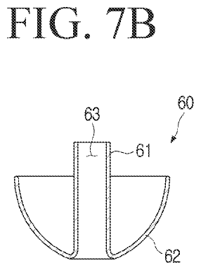

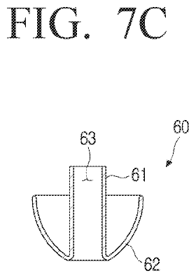

The ear tip 60 may be formed in various sizes. For example, as illustrated in FIGS. 7A, 7B, and 7C, the ear tip 60 may include a large ear tip, a medium ear tip, and a small ear tip.

FIG. 7A is a diagram illustrating an example of a large ear tip 60 attached to an earbud 50 according to various embodiments. FIG. 7B is a diagram illustrating an example of a medium ear tip 60 attached to an earbud 50 according to various embodiments. FIG. 7C is a diagram illustrating an example of a small ear tip 60 attached to an earbud 50 according to various embodiments.

Referring to FIG. 7A, the cap part 62 of the large ear tip 60 may have a large diameter. The coupling part 61 may be formed in a size corresponding to the distal end 51 of the earbud 50.

Referring to FIG. 7B, the diameter of the cap part 62 of the medium ear tip 60 may be smaller than the diameter of the cap part 62 of the large ear tip 60. The coupling part 61 of the medium ear tip 60 may be formed identically to the coupling part 61 of the large ear tip 60.

Referring to FIG. 7C, the diameter of the cap part 62 of the small ear tip 60 may be smaller than the diameter of the cap part 62 of the medium ear tip 60. The coupling part 61 of the small ear tip 60 may be formed identically to the coupling part 61 of the large ear tip 60.

Therefore, the user may select and use an ear tip 60 that fits his/her ear among ear tips 60 of various sizes. The user may attach the selected ear tip 60 to the distal end 51 of the earbud 50. The user may separate and remove the ear tip 60 attached to the earbud 50 and attach a new ear tip 60 to the earbud 50.

The earbud 50 according to various embodiments may identify the size of the ear tip 60 attached to the distal end 51 of the earbud 50 using the reflected sound reflected by the sound reflection deformation portion 30 provided in the earbuds cradle 1 and introduced into the microphone 57.

The pair of earbuds 50 according to various embodiments described above may form an audio system together with an electronic device 100.

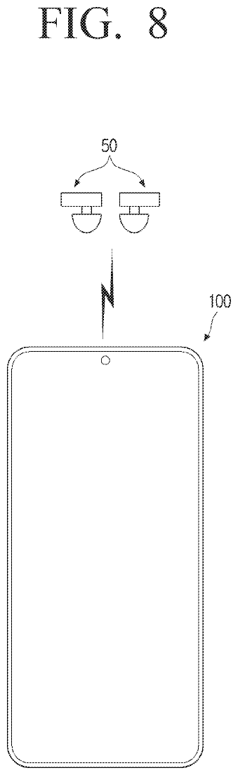

FIG. 8 is a diagram illustrating an example of an audio system using earbuds 50 according to various embodiments.

The earbud 50 may be formed of a hard material such as plastic or metal. The earbud 50 may include at least one speaker 56 (e.g., refer to FIG. 9) configured to reproduce sound, an electronic circuit for operating the speaker 56, and a user interface.

The earbud 50 may operate as an accessory of the electronic device 100. The electronic device 100 may include, for example, and without limitation, a smartphone, a tablet computer, a laptop computer, a desktop computer, a wearable device such as a smart watch, a game console, a handheld game device, or other electronic devices that provide audio output.

The earbud 50 may be connected to the electronic device 100 through a wireless communication channel configured to transmit audio data. The earbud 50 may reproduce sound according to audio data received from the electronic device 100.

The wireless communication channel may be configured so that the earbud 50 and the electronic device 100 can exchange information with each other. For example, the earbud 50 may transmit size information of the identified ear tip 60 to the electronic device 100. The electronic device 100 may adjust its own operation based on the size information of the ear tip 60 received from the earbud 50. For example, the electronic device 100 may adjust a setting value of an equalizer using the size information of the ear tip 60 received from the earbud 50.

FIG. 9 is a block diagram illustrating an example configuration of an earbud 50 according to various embodiments.

Referring to FIG. 9, the earbud 50 may include a speaker 56, a microphone 57, and a processor (e.g., including processing circuitry) 90.

The speaker 56 may be a general audio speaker accommodated inside the earbud 50.

The speaker 56 may include a transducer and an amplifier that convert electrical signals into sounds.

The microphone 57 may be disposed inside the earbud 50, and may be configured to receive sound from the outside of the earbud 50, convert the received sound into an electrical signal, and output the electrical signal.

The processor 90 is accommodated inside the earbud 50 and may include various processing circuitry configured to control the speaker 56 and the microphone 57. The processor 90 may be implemented, for example, and without limitation, as one or more microprocessors, microcontrollers, field programmable gate arrays (FPGAs), general logic circuits, and the like.

The processor 90 may include a plurality of logical module implemented using any suitable combination of hardware and/or software components (e.g., including various processing circuitry and/or executable program instructions).

For example, the processor 90 may include a sound processing part 91. The sound processing part 91 may be configured to receive audio data from the electronic device 100, process the audio data, and drive the speaker 56. For example, the sound processing part 91 may receive audio data from the electronic device 100 connected to the earbud 50. The sound processing part 91 may generate an audio signal by performing signal processing on the received audio data. For example, the sound processing part 91 may perform decoding, digital-to-analog conversion, volume control, and the like. The sound processing part 91 may drive the speaker 56 according to the generated audio signal.

The processor 90 may include an ear tip size identifying part 92. The ear tip size identifying part 92 may identify the size of the ear tip 60 attached to the earbud 50 using sound input to the microphone 57.

For example, when the earbud 50 is mounted on the earbuds cradle 1, the ear tip size identifying part 92 may control the sound processing part 91 to output a sound for identifying an ear tip size through the speaker 56. The sound for identifying an ear tip size may be any one of white noise, pink noise, or a specific sound source of an audible frequency (16 Hz to 20 kHz).

The ear tip size identifying part 92 may store the sound for identifying an ear tip size. Alternatively, the ear tip size identifying part 92 may output a sound for identifying an ear tip size stored in a memory 96.

The ear tip size identifying part 92 may be configured to receive sound using the microphone 57 and analyze the received sound to identify the size of the ear tip 60 attached to the earbud 50. The microphone 57 may be configured to output an electrical signal corresponding to the received sound. The ear tip size identifying part 92 may identify the size of the ear tip 60 attached to the earbud 50 by comparing the electrical signal output from the microphone 57 with reference ear tip sound data stored in the memory 96.

The ear tip size identifying part 92 may be configured to receive sound using the microphone 57 and analyze the received sound to identify the size of the ear tip 60 attached to the earbud 50. The microphone 57 may be configured to convert the received sound into an electrical signal and output the electrical signal. The ear tip size identifying part 92 may identify the size of the ear tip 60 attached to the earbud 50 by comparing the electrical signal output from the microphone 57 with the reference ear tip sound data stored in the memory 96.

The ear tip size identifying part 92 may include an ear tip size identifying algorithm configured to identify the size of the ear tip 60. The ear tip size identifying algorithm may be configured to compare the electrical signals of the reference ear tip sound data with the electrical signal output from the microphone 57.

The ear tip size identifying part 92 may store the identified size of the ear tip 60 in the memory 96.

The reference ear tip sound data may include a plurality of signal data corresponding to the sizes of the ear tips 60. For example, in a state where the earbud 50 to which the large ear tip 60 is attached is mounted on the earbuds cradle 1, when a sound for identifying an ear tip size is output through the speaker 56, the sound may be reflected by the inner surface of the cavity 22 and the sound reflection deformation portion 30 and input to the microphone 57. The microphone 57 may output an electrical signal corresponding to the input reflected sound. The electrical signal output from the microphone 57 may become reference signal data corresponding to the large ear tip 60. Reference signal data corresponding to the medium ear tip 60 and the small ear tip 60 may be made in the same way.

To easily identify the size of the ear tip 60, it is preferable that the characteristic difference of the electric signal output from the microphone 57 is large according to the size of the ear tip 60 attached to the earbud 50. Because the earbud cradle 1 according to one or more embodiments of the disclosure includes the sound reflection deformation portion 30, the characteristic difference of the electrical signal output from the microphone 57 increases depending on the size of the ear tip 60.

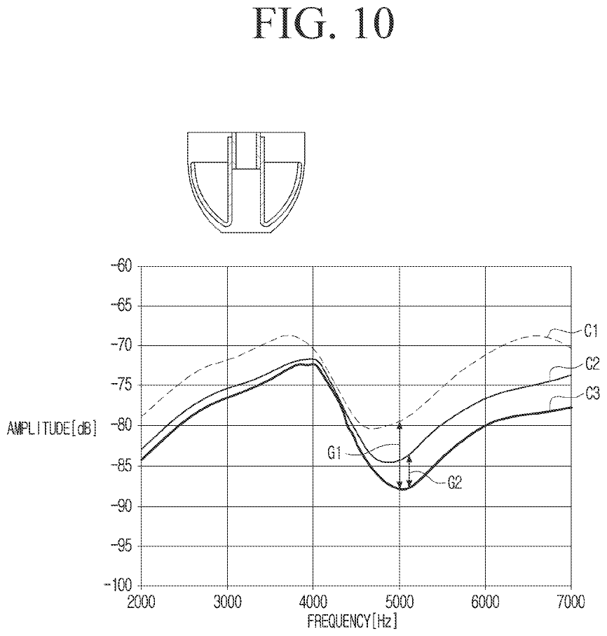

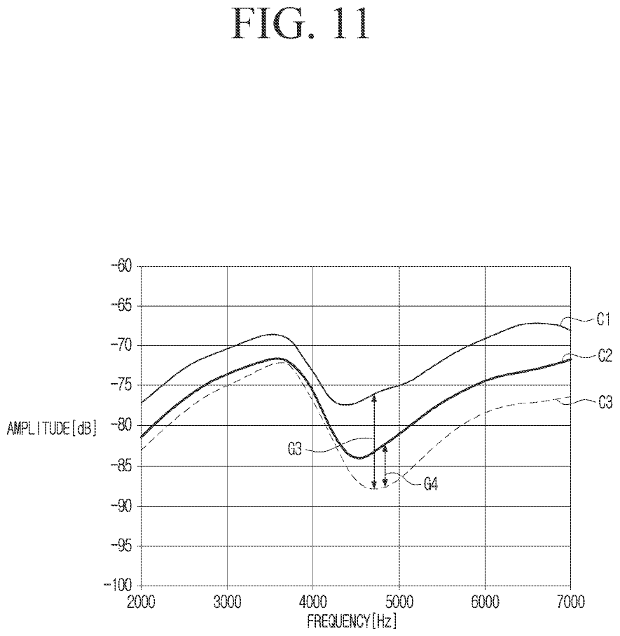

Hereinafter, the electrical signal output from the microphone 57 according to the size of the ear tip 60 changes according to the presence or absence of the sound reflection deformation portion 30 will be described in greater detail below with reference to FIGS. 10 and 11.

FIG. 10 is a graph illustrating signals output from a microphone 57 according to the size of an ear tip 60 of an earbud 50 mounted on an earbuds cradle 1 without a sound reflection deformation portion 30 according to various embodiments.

As illustrated in upper part of FIG. 10, the bottom 20a of the earbud accommodating groove 20 of the earbuds cradle 1 is flat and does not have the sound reflection deformation portion 30. The gap between the ear tip 60 and the bottom 20a of the earbud accommodating groove 20 is about 0.5 mm.

In the lower graph of FIG. 10, the horizontal axis represents frequency Hz and the vertical axis represents amplitude dB. C1 is a curve illustrating an electrical signal output from the microphone 57 when the large ear tip 60 is attached to the earbud 50 (hereinafter, referred to as a large ear tip signal). C2 is a curve illustrating an electrical signal output from the microphone 57 when the medium ear tip 60 is attached to the earbud 50 (hereinafter, referred to as a medium ear tip signal). C3 is a curve illustrating an electrical signal output from the microphone 57 when the small ear tip 60 is attached to the earbud 50 (hereinafter, referred to as a small ear tip signal). When the small ear tip 60 is attached to the earbud 50, at a frequency (about 5 kHz) corresponding to the lowest point of the small ear tip signal curve output from the microphone 57, the difference G1 between the amplitude (about −79.5 dB) of the large ear tip signal and the amplitude (about −83.5 dB) of the small ear tip signal is about 8 dB. Also, the difference G2 between the amplitude (about −83.5 dB) of the medium ear tip signal and the amplitude (about −87.5 dB) of the small ear tip signal is about 4 dB.

FIG. 11 is a graph illustrating signals output from a microphone 57 according to the size of an ear tip 60 of an earbud 50 mounted on an earbuds cradle 1 having a sound reflection deformation portion 30 according to various embodiments. For reference, FIG. 11 illustrating signals when the sound reflection deformation portion 30 is formed as a dome-shaped protrusion as illustrated in FIGS. 1 and 2.

In FIG. 11, the horizontal axis represents frequency Hz and the vertical axis represents amplitude dB. C1 is a curve illustrating an electrical signal output from the microphone 57 when the large ear tip 60 is attached to the earbud 50 (hereinafter, referred to as a large ear tip signal). C2 is a curve illustrating an electrical signal output from the microphone 57 when the medium ear tip 60 is attached to the earbud 50 (hereinafter, referred to as a medium ear tip signal). C3 is a curve illustrating an electrical signal output from the microphone 57 when the small ear tip 60 is attached to the earbud 50 (hereinafter, referred to as a small ear tip signal).

When the small ear tip 60 is attached to the earbud 50, at a frequency (about 4.8 kHz) corresponding to the lowest point of the small ear tip signal curve output from the microphone 57, the difference G3 between the amplitude (about −76 dB) of the large ear tip signal and the amplitude (about −88 dB) of the small ear tip signal is about 12 dB. Also, the difference G4 between the amplitude (about −83 dB) of the medium ear tip signal and the amplitude (about −88 dB) of the small ear tip signal is about 5 dB. As can be seen in FIGS. 10 and 11, when the sound reflection deformation portion 30 is provided on the bottom 20a of the earbud accommodating groove 20 of the earbuds cradle 1, the difference between the sizes of electrical signals output from the microphone 57 depending on the sizes of the ear tips 60 is greater than when the sound reflection deformation portion 30 is not present on the bottom 20a of the earbud accommodating groove 20. Therefore, with the earbuds cradle 1 according to one or more embodiments of the disclosure, the earbud 50 may easily identify the size of the ear tip 60 attached to the earbud 50.

In the above, the method of identifying the size of the ear tip 60 by comparing the amplitudes of electrical signals output from the microphone 57 has been described, but the characteristics of the electrical signal output from the microphone 57 used to identify the size of the ear tip 60 are not limited thereto. For example, the earbud 50 may identify the size of the ear tip 60 using the slope, deviation, inflection point of a curve, and the like of the electrical signal output from the microphone 57.

The reference ear tip sound data may be provided by a manufacturer that manufacture the earbuds cradle 1. For example, the reference ear tip sound data may be provided in a state stored in the memory 96.

Referring back to FIG. 9, the processor 90 may include a correct wearing identifying part 93. The correct wearing identifying part 93 may be configured to identify whether the earbud 50 is correctly worn on the user's ear using a sound input to the microphone 57.

For example, when the user wears the earbuds 50 on his/her ears and reproduces a sound source, the correct wearing identifying part 93 may be configured to identify whether the earbuds 50 are correctly worn using a sound input to the microphone 57. The correct wearing identifying part 93 may receive sound using the microphone 57 and analyze an electrical signal output from the microphone 57 to identify whether the earbud 50 is correctly worn. The microphone 57 may convert the received sound into an electrical signal and output the electrical signal. The correct wearing identifying part 93 may be configured to identify whether the earbud 50 is correctly worn by comparing the electrical signal output from the microphone 57 with correct wearing sound data. The correct wearing sound data may be stored in the memory 96. The correct wearing identifying part 93 may include a correct wearing identifying algorithm configured to identify whether the earbud 50 is correctly worn. The correct wearing identifying algorithm may be configured to compare the magnitudes of the electrical signals of the correct wearing sound data with the magnitude of the electrical signal output from the microphone 57.

The correct wearing sound data may be created using the earbud 50 equipped with the ear tip 60 having a standard size. For example, when the user correctly wears the earbud 50 to which the medium ear tip 60 is attached, an electrical signal output from the microphone 57 may be used as the correct wearing sound data.

The correct wearing sound data may be made and provided by a manufacturer that manufactures the earbuds cradle 1. For example, the correct wearing sound data may be provided in a state stored in the memory 96.

The processor 90 may include an equalizer 95 and an equalizer setting part 94.

The equalizer 95 may be configured to change the frequency characteristics of sound output from the speaker 56 of the earbud 50.

The equalizer setting part 94 may be configured to set setting values of the equalizer 95. The equalizer setting part 94 may be configured to change the setting value of the equalizer 95 using the size information of the ear tip 60 identified by the ear tip size identifying part 92. The equalizer setting part 94 may be configured to change the setting value of the equalizer 95 using the correct wearing information identified by the correct wearing identifying part 93.

The processor 90 may include the memory 96. The memory 96 may be configured to store various data, programs, applications, and the like. The memory 96 may store at least one equalizer setting, volume limit, noise canceling setting, and the like. The memory may store ear tip size information identified by the ear tip size identifying part 92.

The processor 90 may include a communication interface 97. The communication interface 97 may be configured to connect the earbuds 50 and the electronic device 100 wirelessly. The communication interface 97 may form a wireless communication channel to enable two-way communication between the earbuds 50 and the electronic device 100. The communication interface 97 may be implemented with Bluetooth, Wi-Fi, 4G, 5G or the like.

The processor 90 may include a user interface 98. The user interface 98 may be configured so that the user controls the earbuds 50.

The user interface 98 may include a user input module including various input circuitry and/or executable program instructions. The user input module may support user interaction. For example, the user input module may be configured to receive and interpret voice command from the user. The user input module may be configured to detect user control motions. Depending on the received user input, the user input module may provide commands to other modules of the processor 90, such as volume adjustment, adjustment of equalizer setting, and the like. Alternatively, the user input module may be configured to transmit commands or data to the electronic device 100 through the communication interface 97.

The user interface 98 may include a user output module. The user output module may be configured to present information to the user in sound and/or vision.

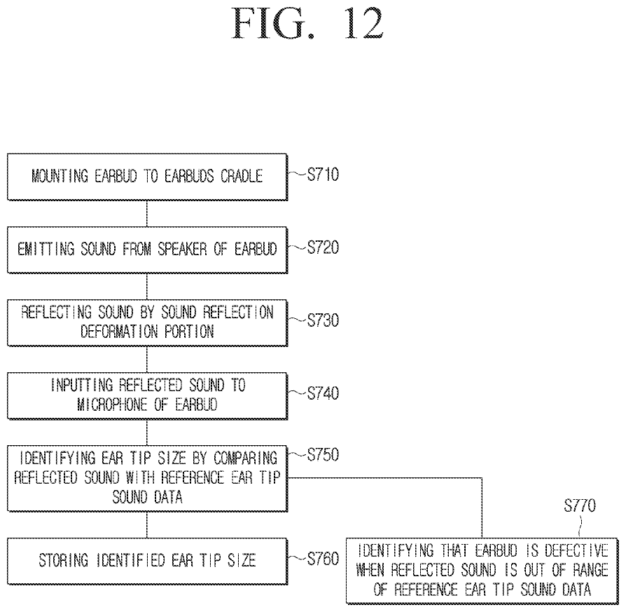

Hereinafter, a method for identifying a size of an ear tip of the earbud 50 according to various embodiments of the disclosure will be described in greater detail below with reference to FIG. 12.

FIG. 12 is a flowchart illustrating an example method for identifying a size of an ear tip of an earbud 50 according to various embodiments.

Referring to FIG. 12, the earbuds 50 may be mounted on the earbuds cradle 1 (S710). In other words, the user may open the lid 40 of the earbuds cradle 1 and place the pair of earbuds 50 in the pair of earbud accommodating grooves 20 formed in the body 10.

The speaker 56 of the earbud 50 may emit sound (S720). In other words, when the earbud 50 are mounted on the earbuds cradle 1, the processor 90 of the earbud 50 controls the sound processing part 91 to output sound through the speaker 56.

For example, the ear tip size identifying part 92 of the processor 90 may control the sound processing part 91 to output a sound for identifying an ear tip size through speaker 56. The sound for identifying an ear tip size may be one of white noise, pink noise, or a specific sound source having an audible frequency (16 Hz to 20 kHz). The sound emitted from the speaker 56 may be reflected by the inner surface of the cavity 22 and the sound reflection deformation portion 30 of the earbud accommodating groove 20 (S730). Most of the sound emitted from the speaker 56 may be reflected by the sound reflection deformation portion 30 disposed to face the coupling part 61 of the ear tip 60. In addition, some sound may be reflected by the inner surface of the cavity 22 of the earbud accommodating groove 20 around the sound reflection deformation portion 30.

The reflected sound may be input to the microphone 57 of the earbud 50 (S740). For example, the sound reflected by the sound reflection deformation portion 30 may be input to the microphone 57 of the earbud 50. When the reflected sound is input, the microphone 57 may convert the sound into an electrical signal and output the electrical signal.

The processor 90 may identify the size of the ear tip 60 by comparing the reflected sound with the reference ear tip sound data (S750). For example, the ear tip size identifying part 92 of the processor 90 may compare the electrical signal output from the microphone 57 with the reference ear tip sound data stored in the memory 96 to identify the size of the ear tip 60 attached to the earbud 50.

The ear tip size identifying part 92 may identify the size of the ear tip 60 using a built-in ear tip size identifying algorithm. The ear tip size identifying algorithm may identify the size of the ear tip 60 by comparing the electrical signals of the reference ear tip sound data with the electrical signal output from the microphone 57.

For example, the ear tip size identifying algorithm may compare the electrical signals of the reference ear tip sound data and the electrical signal output from the microphone 57 at a specific frequency to find a case in which the sizes of the electrical signals are similar. Then, the ear tip size identifying algorithm may identify a reference ear tip having an electrical signal having a similar size as an ear tip currently worn by the user. In other words, when the size of the electrical signal output from the microphone 57 is similar to the size of the electrical signal of the medium ear tip among the reference ear tip sound data, the ear tip size identifying part 92 may identify the ear tip worn by the user as a medium ear tip.

The processor 90 may store the identified size of the ear tip 60 in the memory 96 (S760). In other words, the ear tip size identifying part 92 may store the identified size of the ear tip 60 in the memory 96.

The ear tip size identifying part 92 may identify that the earbud 50 is defective when the reflected sound is out of the range of the reference ear tip sound data (S770). For example, when the characteristics of the electrical signal output from the microphone 57 are significantly different from the electrical signals of the reference ear tip sound data, the ear tip size identifying part 92 may identify that the earbud 50 is defective. For example, the defects of the earbud 50 may include a defect of the speaker 56 or microphone 57 of the earbud 50, insertion of foreign substances into the earbud 50, a case in which foreign substances are inserted into the body 10 of the earbuds cradle 1, and the like.

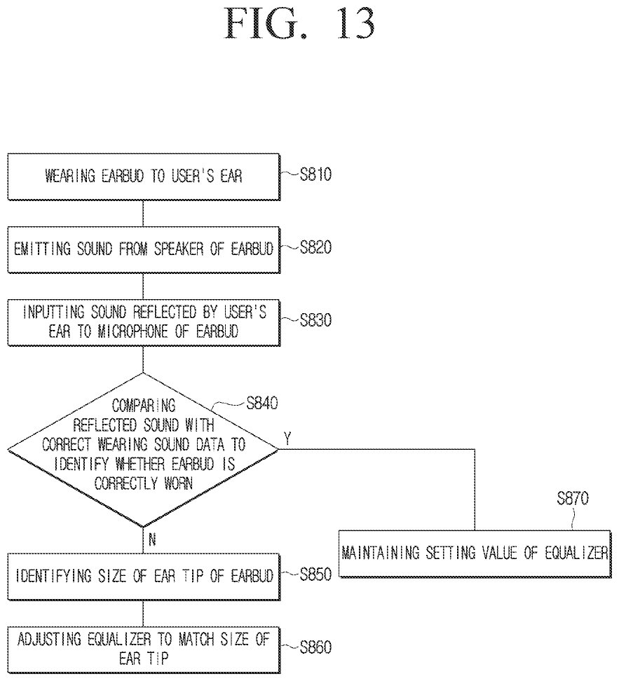

Hereinafter, a method for identifying correct wearing of earbuds according to various embodiments will be described in greater detail below with reference to FIG. 13. Here, the correct wearing of the earbud 50 refers to a state in which the earbud 50 is correctly worn on the user's ear (e.g., the ear canal) and the earbud 50 may perform its originally designed performance.

FIG. 13 is a flowchart illustrating an example method for identifying correct wearing of earbuds according to various embodiments.

Referring to FIG. 13, earbuds 50 may be worn on or in the user's ears (S810). In other words, the user may wear the earbuds 50 on or in his/her ears.

The user may operate the electronic device 100 connected to the earbuds 50 so that the electronic device 100 transmits audio data to the earbuds 50. Then, the speaker 56 of the earbud 50 may emit sound (S820).

The sound emitted from the speaker 56 of the earbud 50 may be reflected by the user's ear and input to the microphone 57 (S830).

The processor 90 may compare the reflected sound with correct wearing sound data to identify whether the earbuds 50 are correctly worn (S840). For example, the correct wearing identifying part 93 of the processor 90 may receive the sound using the microphone 57 and analyze the received sound to identify whether the earbud 50 is correctly worn on the ear or whether the ear tip 60 of an appropriate size is worn. The correct wearing identifying part 93 may compare the electrical signal of the received sound with the electrical signals of the correct wearing sound data to identify whether the earbud 50 is correctly worn on the ear. Whether or not the earbud 50 is correctly worn on the ear may include whether or not an ear tip 60 having a size suitable for the user's ear is worn.

The correct wearing identifying part 93 may identify whether the earbud 50 is correctly worn using a built-in correct wearing identifying algorithm. The correct wearing identifying algorithm may be configured to compare the magnitudes of the electrical signals of the correct wearing sound data with the magnitude of the electrical signal output from the microphone 57.

For example, the correct wearing identifying part 93 may identify that the earbud 50 is not correctly worn when the intensity of the low frequency band of the electrical signal output from the microphone 57 that has received the reflected sound is less than or equal to a predetermined value.

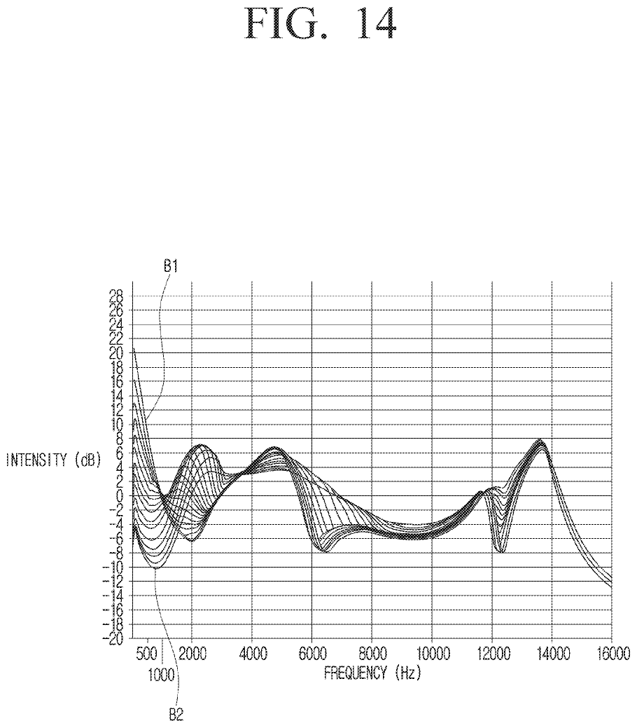

As the distance between the earbud 50 and the ear canal of the ear increases, the intensity in the low frequency band may greatly differ. The electrical signals output from the microphone 57 are shown, for example, in FIG. 14.

FIG. 14 is a graph illustrating electrical signals output from a microphone when an earbud is correctly worn in an ear canal of an ear and when a distance between the earbud and the ear canal is greater than when the earbud is correctly worn in the ear canal of the ear according to various embodiments.

In FIG. 14, B1 is a curve illustrating the change in intensity according to the frequency when the earbud is correctly worn on the ear canal. B2 is a curve illustrating the change in intensity according to frequency when the distance between the earbud and the ear canal is 10 mm larger than when the earbud is correctly worn on the ear canal. A plurality of curves between B1 and B2 are curves illustrating changes in intensity according to frequency when the distance between the earbud and the ear canal is less than 10 mm than when the earbud is correctly worn on the ear canal of the ear.

Referring to FIG. 14, at 1000 Hz, the intensity is about 0 dB when the earbuds are correctly worn (curve B1), and when the distance between the earbud and the ear canal is 10 mm larger than when the earbuds are correctly worn (curve B2), the intensity is about −10 dB. In addition, at 500 Hz, the intensity is about 10 dB when the earbuds are correctly worn (curve B1), and when the distance between the earbud and the ear canal is 10 mm larger than when the earbuds are correctly worn (curve B2), the intensity is about −9 dB.

For example, the correct wearing identifying algorithm may use the curve B1 of FIG. 14 as an electrical signal of the correct wearing sound data. In this case, the correct wearing identifying algorithm may compare the intensity of the low frequency band of the electrical signal input from the microphone, for example, the intensity at 500 Hz or 1000 Hz with the intensity of the electrical signals of the correct wearing sound data. When the intensity of the electrical signal input from the microphone is similar to that of the correct wearing sound data, it may be identified that the earbuds are correctly worn and the ear tips 60 of a size suitable for the user's ears are worn.

However, when the intensity of the electrical signal input from the microphone is greater than the intensity of the electrical signal of the correct wearing sound data by a predetermined value, the correct wearing identifying part 93 may identify that the earbud 50 is not correctly worn or that the ear tip 60 of the earbud 50 is not suitable for the size of the user's ear canal.

When the earbud 50 is correctly worn or the ear tip 60 of the earbud 50 is suitable for the size of the user's ear canal (Y), the correct wearing identifying part 93 may cause the equalizer 95 to maintain the current setting value (S870).

When the earbud 50 is not correctly worn or the ear tip 60 of the earbud 50 is not suitable for the size of the user's ear canal (N), the correct wearing identifying part 93 may identify the size of the ear tip 60 of the earbud 50 (S850).

After that, the correct wearing identifying part 93 may adjust the equalizer 95 to match the size of the ear tip 60 (S860). For example, the correct wearing identifying part 93 may adjust the setting value of the equalizer 95 by controlling the equalizer setting part 94 to match the size of the ear tip 60 of the earbud 50.

When the earbud 50 is not correctly worn or the size of the ear tip 60 is small, the volume of a low frequency band of 1000 Hz or less may be transmitted to the user. Accordingly, the volume may be increased in a low frequency band of 1000 Hz or less. In the middle frequency band in the range of 1000 Hz to 2500 Hz, the setting value of the equalizer may be adjusted so that the gain may be adjusted to match the size of each frequency when the earbuds are correctly worn. In this case, the setting value of the equalizer corresponding to the size of the ear tip 60 may be embedded in the correct wearing identifying part 93 or stored in the memory 96.

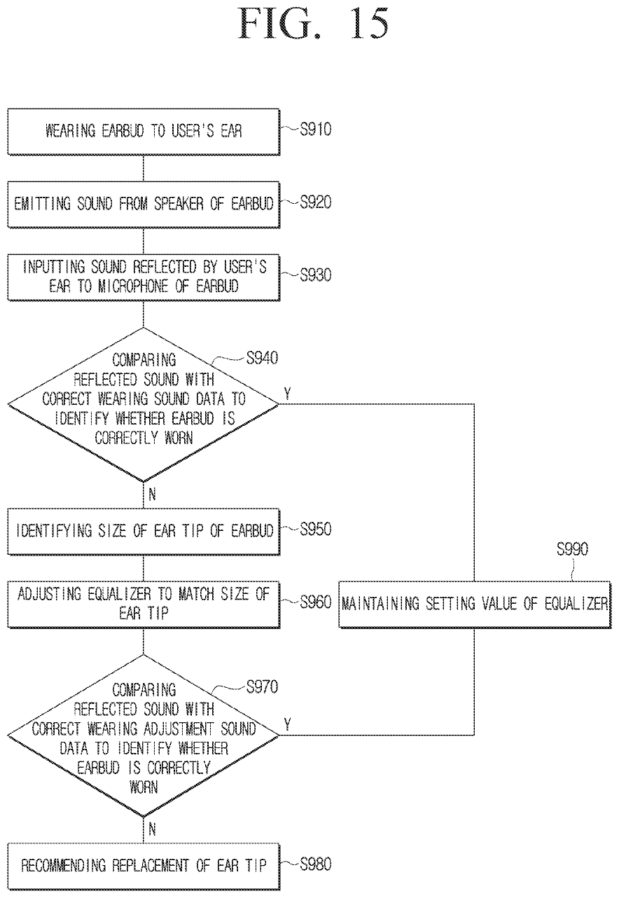

The method for identifying correct wearing of earbuds according to various embodiments may recommend replacement of the ear tip when the earbuds are not correctly worn. Hereinafter, this will be described in greater detail below with reference to FIG. 15.

FIG. 15 is a flowchart illustrating an example method for identifying correct wearing of earbuds according to various embodiments.

Referring to FIG. 15, earbuds 50 may be worn on the user's ears (S910). In other words, the user may wear the earbuds 50 on his/her ears.

When an electronic device 100 connected to the earbuds 50 transmits audio data to the earbuds 50, the speaker 56 of the earbud 50 may emit sound (S920).

The sound emitted from the speaker 56 of the earbud 50 may be reflected by the user's ear and input to the microphone 57 of the earbud 50 (S930).

The earbud 50 may compare the reflected sound with correct wearing sound data to identify whether the earbuds 50 are correctly worn (S940). For example, the correct wearing identifying part 93 of the processor 90 of the earbud 50 may receive the sound using the microphone 57 and analyze the received sound to identify whether the earbud 50 is correctly worn on the ear. The correct wearing identifying part 93 may compare the electrical signal output from the microphone 57 that has received the reflected sound with the electrical signals of the correct wearing sound data to identify whether the earbud 50 is correctly worn on the ear.

The correct wearing identifying part 93 may identify whether the earbud 50 is correctly worn using a built-in correct wearing identifying algorithm.

Identifying whether the earbud 50 is correctly worn by the correct wearing identifying part 93 is the same as or similar to the above-described embodiment. Therefore, a detailed description thereof may not be repeated here.

When the earbud 50 is correctly worn (Y), the correct wearing identifying part 93 may cause the equalizer 95 to maintain the current setting value (S990).

When the earbud 50 is not correctly worn (N), the correct wearing identifying part 93 may identify the size of the ear tip 60 of the earbud 50 (S950).

The correct wearing identifying part 93 may adjust the equalizer to match the size of the ear tip (S960). For example, the correct wearing identifying part 93 may adjust the setting value of the equalizer by controlling the equalizer setting part to match the size of the ear tip of the earbud 50.

The earbud 50 may compare the reflected sound with correct wearing adjustment sound data to identify whether the earbud 50 is correctly worn (S970). For example, the correct wearing identifying part 93 of the processor 90 of the earbud 50 may receive sound using the microphone 57 and analyze the received sound to identify whether the earbud 50 is correctly worn on the ear. The correct wearing identifying part 93 may compare the electrical signal output from the microphone 57 that has received the reflected sound with the electrical signals of the correct wearing adjustment sound data to identify whether the earbud 50 is correctly worn on the ear. For example, the correct wearing identifying part 93 may identify that the earbud 50 is not correctly worn when the intensity of the low frequency band of the electrical signal output from the microphone 57 that has received the reflected sound is less than or equal to a predetermined value.

The identification of whether the earbud 50 is correctly worn by comparing the electrical signals of the correct wearing adjustment sound data with the electrical signal input from the microphone 57 by the correct wearing identifying part 93 is the same as or similar to the above-described embodiment, so detailed description thereof may not be repeated here.

The correct wearing adjustment sound data refers to sound data obtained by adjusting the correct wearing sound data according to the size of the ear tip. For example, in the case that the correct wearing sound data is made based on a medium ear tip, when the ear tip attached to the earbud 50 is small, sound data obtained by adjusting the correct wearing sound data to correspond to the small ear tip may be referred to as the correct wearing adjustment sound data.

Such correct wearing adjustment sound data may be made and provided by a manufacturer that manufactures the earbuds cradle 1. For example, the correct wearing adjustment sound data may be provided in a state stored in the memory 96. When the earbud 50 is correctly worn (Y), the correct wearing identifying part 93 may cause the equalizer 95 to maintain the current setting value (S990).

When the earbud 50 is not correctly worn (N), the correct wearing identifying part 93 may recommend replacing the ear tip 60 of the earbud 50 (S980). For example, when the current ear tip 60 of the earbud 50 is not a large ear tip, the correct wearing identifying part 93 may recommend a larger ear tip. In detail, when the ear tip 60 of the earbud 50 worn by the user is small, the correct wearing identifying part 93 may recommend replacing the small ear tip with a medium ear tip or a large ear tip.

The correct wearing identifying part 93 may recommend replacement of the ear tip 60 through the user interface 98 of the processor 90 with sound. The correct wearing identifying part 93 may transmit ear tip replacement information to the electronic device so that electronic device displays the ear tip replacement on the display.

As described above, because the earbuds cradle 1 according to various embodiments has the sound reflection deformation portion 30 provided in the earbud accommodating groove 20, the characteristic change according to the frequency of the electrical signal output from the microphone 57 may be increased. Therefore, the earbuds cradle 1 according to one or more embodiments of the disclosure may identify the size of the ear tip 60 attached to the distal end 51 of the earbud 50 using the electrical signal output from the microphone 57.

In addition, the earbuds cradle 1 according to various embodiments may identify whether the earbuds 50 are correctly worn using the electrical signal output from the microphone 57. When the earbuds 50 are not correctly worn, the earbuds cradle 1 according to various embodiments may recommend to replace the ear tip 60.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An earbuds cradle comprising:
a body;
a pair of earbud accommodating grooves provided on a upper surface of the body and configured to accommodate a pair of earbuds;
a sound reflection deformation portion provided at a bottom of each of the pair of earbud accommodating grooves; and
a lid disposed on the body and configured to cover the pair of earbuds.

2. The earbuds cradle of claim 1, wherein
the sound reflection deformation portion comprises a protrusion protruding from the bottom of each of the earbud accommodating grooves.

3. The earbuds cradle of claim 2, wherein
the protrusion has a shape including any one shape of a dome, a cylinder, a cone, a truncated cone, a polygonal column, a polygonal pyramid, and a polygonal truncated pyramid.

4. The earbuds cradle of claim 1, wherein
the sound reflection deformation portion includes a groove formed in the bottom of each of the earbud accommodating grooves.

5. The earbuds cradle of claim 4, wherein:
the groove includes a shape including any one shape of a concave curved surface, a circular cross-section groove, a polygonal cross-section groove, a conical groove, a truncated cone groove, a polygonal pyramidal groove, and a polygonal truncated pyramidal groove.

6. The earbuds cradle of claim 1, wherein
each of the pair of earbuds comprises:
a distal end including a passage configured to emit sound; and
an ear tip detachably coupled to the distal end,
wherein the ear tip includes any one of a large ear tip, a medium ear tip, and a small ear tip, and
wherein the sound reflection deformation portion is provided to face the ear tip.

7. The earbuds cradle of claim 6, wherein
the sound reflection deformation portion is configured so that difference in reflected sound of the sound emitted from the earbud according to a size of the ear tip attached to the earbud is larger than based on the bottom of the earbud accommodating groove being flat.

8. The earbuds cradle of claim 6, wherein
the ear tip comprises a coupling part configured to be coupled to the distal end of the earbud and through which the sound passes, and
wherein the sound reflection deformation portion includes a protrusion having a tip configured to be inserted into the coupling part.

9. A method for identifying a size of an ear tip of an earbud, the method comprising:
mounting the earbud including the ear tip on an earbuds cradle;
emitting sound from a speaker of the earbud;
reflecting the sound by a sound reflection deformation portion of the earbuds cradle;
inputting the reflected sound to a microphone of the earbud; and
identifying the size of the ear tip by comparing an electrical signal, corresponding to the reflected sound, output from the microphone with reference ear tip sound data.

10. The method of claim 9 further comprising:
identifying that the earbud is defective based on the electrical signal output from the microphone being out of a range of the reference ear tip sound data.

11. A method for identifying correct wearing of an earbud, the method comprising:
wearing the earbud including an ear tip to a user's ear;
emitting sound from a speaker of the earbud;
inputting sound reflected by the user's ear to a microphone of the earbud;
comparing an electrical signal corresponding to the reflected sound, output from the microphone with correct wearing sound data to identify whether the earbud is correctly worn or whether a size of the ear tip is suitable for the user's ear; and
maintaining a setting value of an equalizer based on the earbud being correctly worn or based on the size of the ear tip being suitable for the user's ear.

12. The method of claim 11 further comprising:
identifying the size of the ear tip based on the earbud not being correctly worn or based on the size of the ear tip not being suitable for the user's ear; and
adjusting the setting value of the equalizer to match the size of the ear tip.

13. The method of claim 12 further comprising:
comparing the reflected sound with correct wearing adjustment sound data to identify whether the earbud is correctly worn; and
recommending replacement of the ear tip based on the earbud not being correctly worn.

14. The method of claim 12, wherein
the adjusting the setting value of the equalizer to match the size of the ear tip comprises increasing intensity of a low frequency band and decreasing intensity of a middle frequency band.

15. The method of claim 11, wherein
the comparing an electrical signal corresponding to the reflected sound, output from the microphone with correct wearing sound data to identify whether the earbud is correctly worn comprises comparing an intensity of the electrical signal output from the microphone with an intensity of electrical signals of the correct wearing sound data in a frequency range of 500 Hz to 1000 Hz.
